(19) United States
(12) Patent Application Publication
(10) Pub. No.: US 2009/0259577 A1
(43) Pub. Date: Oct. 15, 2009

(54) Providing Billing Instructions Associated With a New Protocol in a Network Environment

(75) Inventors: Robert M. Batz, Raleigh, NC (US); Robert A. Mackie, Cary, NC (US); Chris O'Rourke, Apex, NC (US); Humberto M. Tavares, Cary, NC (US); Walter G. Dixon, Fuquay Varina, NC (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 12/100,838

(22) Filed: Apr. 10, 2008

(51) Int. Cl. G06Q 30/00

(52) U.S. Cl. 705/34

(57) ABSTRACT

In one embodiment, a method includes receiving one or more billing instructions, the billing instructions being operable to initiate one or more billing actions associated with one or more token combinations. The billing actions are performed when the one or more token combinations match a portion of a received protocol. The matched portion of the protocol is associated with a new, unknown, or emerging protocol or protocol extension.

### TECHNICAL FIELD

This disclosure relates in general to the field of communications and, more particularly, for providing billing instructions associated with a new protocol in a network environment.

### BACKGROUND

Data networking architectures have grown increasingly complex in communication systems and environments. Some network equipment may be used to bill end users for services during a transaction. When an end user communicates with a network server during the transaction, the end user generally incurs a charge associated with the use of network resources and/or the value of the content received from the network server.

As the technology for network services evolves, new protocols and new extensions to existing protocols are implemented in a communication system. Efficient and timely methods for providing billing instructions for these new protocols and protocol extensions become even more critical. Thus, the ability to properly and quickly provide billing instructions for the new protocols and protocol extensions in a network environment presents a significant challenge to system designers and network operators.

### BRIEF DESCRIPTION OF THE DRAWINGS

FIG. 1A illustrates an example system for providing billing instructions associated with a new protocol or protocol extension;

FIG. 1B illustrates a simplified block diagram of a configurable protocol parser;

FIG. 2A illustrates an example method for providing billing instructions associated with a new protocol or protocol extension; and

FIG. 2B illustrates another example method for providing billing instructions associated with a new protocol or protocol extension.

### DESCRIPTION OF EXAMPLE EMBODIMENTS

Overview

In one embodiment, a method includes receiving one or more billing instructions, such that the billing instructions are operable to perform one or more billing actions associated with one or more token combinations. The billing actions are performed when the one or more token combinations match a portion of a received protocol. The matched portion of the protocol is associated with a new, unknown, or emerging protocol or protocol extension.

Description

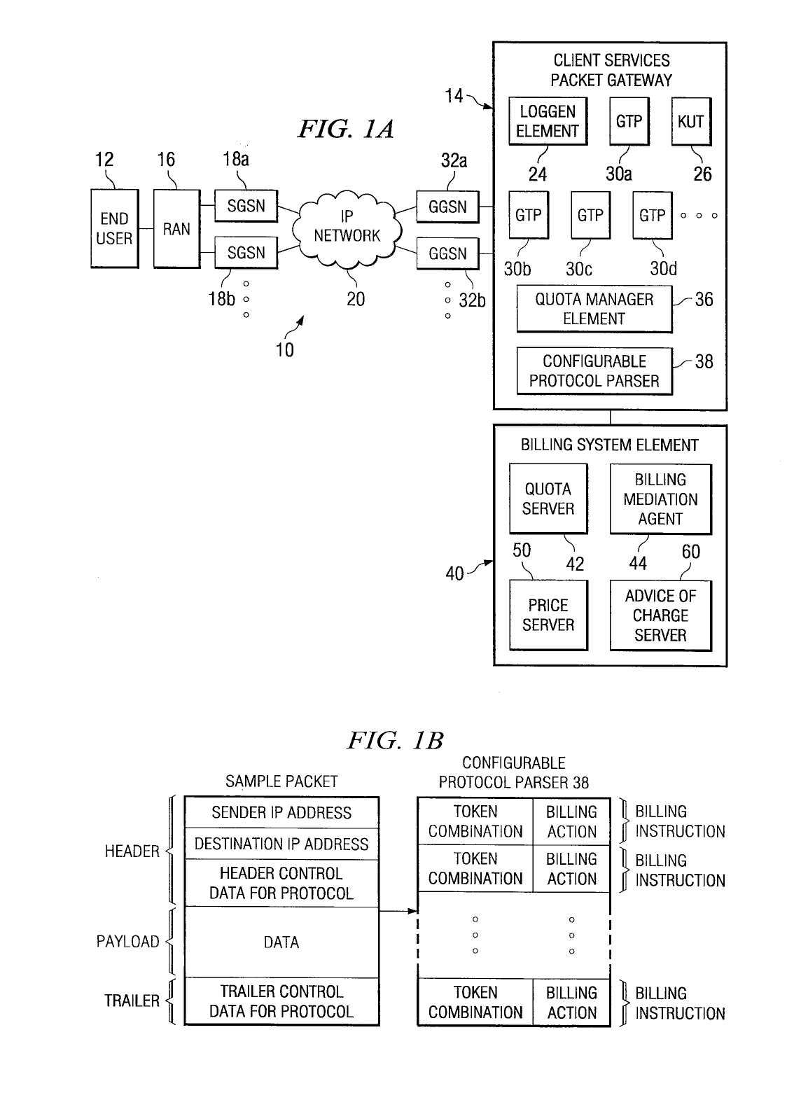

FIG. 1A is a simplified block diagram of a communication system 10 for providing billing instructions associated with a new protocol or protocol extension in a network environment. Communication system 10 includes an end user 12, a client services packet gateway 14, a radio access network (RAN) 16, multiple serving general packet radio service (GPRS) support node (SGSN) 18a and 18b, and an internet protocol (IP) network 20. Additionally, communication system 10 includes multiple gateway GPRS support nodes (GGSNs) 32a-b. Client services packet gateway 14 may include a loggen element 24, a known user table (KUT) 26, multiple GPRS tunneling protocol (GTP) communications protocol elements 30a-d that facilitate communications between client services packet gateway 14 and any billing entity within communication system 10, a quota manager element 36, and a configurable protocol parser 38. Communication system 10 may additionally include a billing system element 40 that may include a quota server 42 and a billing mediation agent (BMA) 44. Billing system element 40 may also include a price server 50 and an advice of charge server 60.

FIG. 1A may be generally configured or arranged to represent a 2.5G communication architecture applicable to a Global System for Mobile (GSM) environment in accordance with a particular embodiment of the present disclosure. However, the 2.5G architecture is offered for purposes of example only and may alternatively be substituted with any suitable networking protocol or arrangement that provides a communicative platform for communication system 10. For example, communication system 10 may cooperate with any version of a GPRS tunneling protocol (GTP) that could benefit from a billing function being provided for any network element. This may be inclusive of first generation, 2G, and 3G architectures that provide features and services for any end user 12. Moreover, communication system 10 could be applied to any access network/protocol that allows end user 12 to create sub-connections, which specify differential treatment for packets in those connections. Furthermore, the relaying of such information into one or more client services packet gateway elements could be implemented in any such network/access technology.

According to the illustrated embodiment, system 10 provides services such as communication sessions to endpoints such as end user 20. A communication session refers to an active communication between endpoints. Information may be communicated during a communication session. Information may include voice, data, text, audio, video, multimedia, control, signaling, and/or other information. Information may be communicated in packets, each comprising a bundle of data organized in a specific way for transmission. Each session can have a session key. The session key can include TCP or UDP port information, IP protocol information, such as TCP or UDP, and virtual routing and forwarding (VRF) information.

In accordance with the teachings of the present disclosure, communication system 10 operates to efficiently and quickly provide new billing instructions for new, unknown, or emerging protocols and protocol extensions. An operator of client services packet gateway 14 (or any other authorized) user may configure these new billing instructions for new protocols and protocol extensions on client services packet gateway 14. A billing instruction may perform a billing event if a portion of the new protocol or protocol extension is matched against one or more token combinations associated with the billing instruction. By utilizing simple matching operations, configurable protocol parser 38 allows the operator of client services packet gateway 14 or any other authorized user to perform billing actions for a new protocol or protocol extension even if the operator or authorized individual only knows a few tokens and/or characteristics associated with the new, unknown, or emerging protocol or protocol extension. Additionally, the simple matching operations utilized by configurable protocol parser 38 allow an operator or authorized individual to perform billing actions on a new, unknown, or emerging protocol or protocol extension such that the operator or authorized individual does not need to understand the complexities of the entire new, unknown, or emerging protocol or protocol extension. As a result, the operator or authorized individual may quickly implement billing instructions for billing end users in response to new protocols or protocol extensions. Additionally, the billing instructions received by configurable protocol parser 38 may be more fault tolerant because the configurable protocol parser 38 may not require identifying the entire protocol, which may require complex algorithms. For example, configurable protocol parser 38 may perform simple algorithms for initiating a billing event associated with the new protocol or protocol extension if a token combination is matched to a portion of the new protocol or protocol extension. Configurable protocol parser 38 allows operators or authorized individuals to quickly and easily install billing instructions for performing billing actions associated with a new, unknown, or emerging protocol or protocol extension.

For purposes of teaching and discussion, it is useful to provide some overview as to the way in which the following architecture operates. The following foundational information may be viewed as a basis from which the present disclosure may be properly explained. Such information is offered earnestly for purposes of explanation and discussion only and, accordingly, should not be construed in any way to limit the broad scope of the present disclosure and its potential applications.

Generally, a billing gateway provides charging services for subscriber transactions. When the subscriber communicates with a network server for the transaction, the subscriber incurs a charge associated with the use of network resources and/or the value of the retrieved content.

Normally, when a billing gateway processes IP packets, the billing gateway associates the IP packet with a subscriber to apply charging policies or other policies, such as QoS, to the IP packet. The billing gateway will associate an IP packet with a subscriber to charge who is in the billing gateway's table of subscribers. The billing gateway may use the source IP address or the destination IP address of the IP packet to search its subscriber table to bill the correct subscriber.

Normally, when a billing gateway processes IP packets, the billing gateway associates the IP packet with one or more billing policies and/or billing instructions associated with a particular protocol, such that the billing policy and/or billing instruction contains one or more billing actions associated with the particular protocol. When a billing gateway is developed, only the current protocols utilized by end users in the network environment are associated with billing policies and/or billing instructions.

New billable protocols and/or protocol extensions frequently appear on networks with little advance notice. When these new, unknown, or emerging protocols or protocol extensions are utilized by end users, the billing gateway does not have billing policies or billing instructions to bill end users for these new, unknown, or emerging protocols. Normally, operators or authorized users of the billing gateway will rely on the developers of the billing gateway to develop new billing policies or billing instructions for the new, unknown, or emerging protocols or protocol extensions. The new billing policies or billing instructions may be developed and then installed for future releases of the billing gateway. However, developers may take months or even years before releasing the updated billing gateways operable to associate billing policies and billing instructions for the new, unknown, or emerging protocols or protocol extensions.

Another attempt to solve this problem involves installing a virtual machine on the billing gateway, such that a formal grammar for billing new, unknown, or emerging protocols can be compiled and loaded on existing billing gateways. However, the formal grammar providing the new billing instructions and/or billing policies for new, unknown, or emerging protocols or protocol extensions is so complicated that the development time takes several weeks. Protocol designers may intentionally create a complex protocol or intentionally obfuscate the protocol, such that the formal grammar is further complicated attempting to provide billing instructions and/or billing policies for these protocols. Additionally, protocol designers may frequently change the protocols to avoid detection by network operators. Thus, the operator or authorized user of the billing gateway is dependent on the developers of the billing gateway or outside contractors for developing billing instructions and/or billing policies for the new, unknown, or emerging protocols or protocol extensions. Additionally, the formal grammar will cause errors if the entire protocol is not recognized. Each particular operator or authorized user of the billing gateway may require their own customized preferences on how to perform the billing instructions and/or billing policies which may cause further delay from a third party development team.

Configurable protocol parser 38, discussed below in more detail, allows the operator or authorized user of the billing gateway to quickly develop billing instructions and/or billing policies for the new, unknown, or emerging protocols or protocol extensions. Configurable protocol parser 38 uses a simple and efficient method for determining if a billing action should occur for new, unknown, or emerging protocols or protocol extensions. As a result, the operator or authorized user of the billing gateway can develop these new billing instructions and/or billing policies on their own. An operator or authorized individual of a billing gateway utilizing configurable protocol parser 38 may quickly respond to these new, unknown, or emerging protocols by writing simple billing instructions in one day, rather than a few weeks or a few months that were required previously. For example, configurable protocol parser 38 allows network operator to experiment with billing techniques based on observations or characteristics of the new, unknown, or emerging protocols. Configurable protocol parser 38 allows network operator to rapidly deploy data mining and primitive billing on the new, unknown, or emerging protocols.

Configurable protocol parser 38 allows network operator to match specific characteristics of the protocol rather than match the entire protocol. Thus, the simple matching methods are more fault tolerant because only a portion of a protocol is required to be identified to perform a billing action. In one embodiment, the simple matching methods utilized by the configurable protocol parser 38 may require less processing and consume less power than the more complex matching techniques required to correctly match an entire protocol. These simple matching methods utilized by configurable protocol parser 38 allow the configurer to match specific characteristics of a protocol currently utilized in the network that may not have been known when billing gateway was manufactured. Configurable protocol parser 38 allows configurer to bill new, unknown, or emerging protocols with observable characteristics that have a matchable pattern.

A protocol may be a set of rules for data representation, signaling, authentication, and/or error detection for transmitting information over IP network 20. A protocol may be a file transfer protocol (FTP), a point to point protocol (PPP), a transmission control protocol (TCP), etcetera. An established protocol may be a publicly recognizable protocol that has been utilized on IP network 20, such that the billing gateway contains billing policies and/or billing instructions associated with the entire protocol. A new protocol may be a protocol that is recently implemented for use on IP network, such that the billing gateway does not contain billing policies and/or billing instructions associated with the new protocol. An unknown protocol may be a protocol that is not publicly recognized, such that the billing gateway does not contain billing policies and/or billing instructions associated with the unknown protocol. An emerging protocol may be a protocol that is publicly recognizable, but the emerging protocol may not be currently utilized on IP network, such that the billing gateway does not contain billing policies and/or billing instructions associated with the emerging protocol. A protocol extension may be one or more rules added to an existing protocol for data representation, signaling, authentication, and/or error detection for transmitting information over IP network 20.

A billing instruction may be logic that is operable to initiate one or more billing actions if a token combination is matched to a portion of the protocol. A billing action may be logic that performs an action associated with a network flow, such as generating a billing record, tracking data, denying one or more packets, permitting one or more packets, etcetera. A token combination may be one or more tokens. A token may be any symbol, character, number, or space.

Referring back to FIG. 1, end user 12 is a client, customer, subscriber, entity, source, or object seeking to initiate network communication in communication system 10 via IP network 20. End user 12 may be inclusive of devices used to initiate a communication, such as a computer, a personal digital assistant (PDA), a laptop or an electronic notebook, a telephone, a mobile station, or any other device, component, element, or object capable of initiating voice or data exchanges within communication system 10. End user 12 may also be inclusive of a suitable interface to the human user, such as a microphone, a display, a keyboard, or other terminal equipment (such as for example an interface to a personal computer or to a facsimile machine in cases where end user 12 is used as a modem). End user 12 may also be any device that seeks to initiate a communication on behalf of another entity or element, such as a program, a database, or any other component, device, element, or object capable of initiating a voice or a data exchange within communication system 10. Data, as used herein in this document, refers to any type of packet, numeric, voice, video, audio-visual, or script data, or any type of source or object code, or any other suitable information in any appropriate format that may be communicated from one point to another.

RAN 16 is a communications interface between end user 12 and SGSNs 18a and 18b. RAN 16 may comprise a base transceiver station and a base station controller in one embodiment. The communications interface provided by RAN 16 offers connectivity and allows data to be exchanged between end user 12 and any number of selected elements within communication system 10. RAN 16 facilitates the delivery of a request packet generated by end user 12 and the reception of information sought by end user 12. RAN 16 is only one example of a communications interface between end user 12 and SGSNs 18a and 18b. Other types of communications interfaces may be used for a desired network design based on particular needs.

SGSNs 18a and 18b and GGSNs 32a and 32b are communication nodes or elements that cooperate in order to facilitate a communication session involving end user 12. GGSNs 32a-b are communications nodes operating in a GPRS environment that may be working in conjunction with multiple SGSNs 18a and 18b to provide a communications medium in a GPRS service network. GGSNs 32a and 32b may be inclusive of a walled garden (providing a security or an access functionality to communication system 10) or any other suitable mechanism that a network operator may choose to implement in providing some connectivity for a network. GPRS represents a packet-based data bearer service for communication services that may be delivered as a network overlay for any type of suitable network configuration or platform. GPRS may support multiple internet communication protocols and may enable existing IP, point to point protocol (PPP), or any other suitable applications or platforms to operate over a given network.

IP network 20 represents a series of points or nodes of interconnected communication paths for receiving and transmitting packets of information that propagate through communication system 10. IP network 20 offers a communicative interface between end user 12 and selected GGSNs 32a-b and may be any local area network (LAN), wireless local area network (WLAN), metropolitan area network (MAN), wide area network (WAN), virtual private network (VPN), or any other appropriate architecture or system that facilitates communications in a network environment. IP network 20 may implement a user datagram protocol (UDP)/internet protocol (UDP/IP) connection and use a transmission control protocol (TCP/IP) communication language protocol in particular embodiments of the present disclosure. However, IP network 20 may alternatively implement any other suitable communication protocol for transmitting and receiving data or information within communication system 10.

Client services packet gateway 14 may represent a piece of network equipment that can facilitate some type of accounting service for communication system 10. Client services packet gateway 14 may be a wireless application protocol (WAP) gateway, a compression and/or optimization engine, a billing engine (inclusive of per-content billing), a service enforcement element, a content authorization component, a policy enforcement gateway, or any other element that is operable to modify, process, or transform data or information in a network environment. This may be inclusive of simple routers, switches, loadbalancers, gateways, bridges, or any other piece of network equipment where appropriate and based on particular needs. Client services packet gateway 14 may represent any component, device, element, or object that can benefit from having suitable billing instructions provided to it such that appropriate billing may be achieved. Client services packet gateway 14 can efficiently extract information from a packet or a packet flow to associate with end user or a protocol. Client services packet gateway 14 may be operable to extract the information from a packet or packet flow into tokens.

Client services packet gateway 14 utilizes the identity of a protocol to provide billing actions based on a billing policy. In a particular embodiment of the present disclosure, client services packet gateway 14 provides client-aware services by operating at networking layers four, five, six, and seven. Accordingly, the information available at networking layers four through seven provides a basis for the identification of a protocol. Client services packet gateway 14 may use header control data or any other suitable parameter to identify a protocol in offering a service, enhanced capability, or feature to an end user. Client services packet gateway 14 may include any suitable hardware, software, components, or elements that identify a protocol in order to provide some networking feature or capability to an end user.

Client services packet gateway 14 may also utilize the identity of end user 12 to provide services based on a source profile. In a particular embodiment of the present disclosure, client services packet gateway 14 provides client-aware services by operating at networking layers two and three. Accordingly, the information available at networking layers two and three provides a basis for the identification of an end user or a client. Client services packet gateway 14 may use an IP address or any other suitable parameter to uniquely identify a client or an end user in offering a service, enhanced capability, or feature to an end user. Client services packet gateway 14 may include any suitable hardware, software, components, or elements that identify a unique identifier in order to provide some networking feature or capability to an end user.

Client services packet gateway 14 may also be a client-aware device that provides or offers some service or feature to end user 12. Such services may be based on an effective mapping between a protocol and a billing action associated with the protocol. Client services packet gateway 14 may include a RADIUS component that may receive RADIUS updates and parse the updates. In addition, client services packet gateway 14 may execute some action based on the RADIUS updates it receives. Client services packet gateway 14 may be provided with accounting, authorization and authentication (AAA) capabilities where appropriate. Alternatively, these capabilities may be provided external to client services packet gateway 14, for example, in an AAA server.

Client services packet gateway may seek to identify the protocol associated with a communication session or data flow. For example, some devices may wish to identify a protocol for authorization purposes. In another example, a device may wish to maintain user profiles for billing or accounting records (for example, in conjunction with per-user accounting) or to provide for content billing information. Alternatively, a device or a component may use the identification of protocol to provide for any other type of suitable client-aware service, tool, or feature according to the particular needs of network operators. Additional services may be related to areas such as routing, permissions or access-granting mechanisms, priority, quality of service (QoS), firewalling, content filtering, or any other suitable parameters or policies where user-aware characteristics serve as a basis for a network service implementation.

Client services packet gateway 14 may be inserted into a data flow that may view, extract, identify, access, bill, or otherwise monitor information included within the data flow. Client services packet gateway 14 may handle the enforcement of access, quota distribution, and accounting that is provided by the information retrieved from elements included within billing system element 40. Client services packet gateway 14 may generally create billing records for end users 12 based on the data flow. Each protocol associated with a data flow may be processed and billed in a unique way. Client services packet gateway 14 may generally deduct quota after it has been properly allocated and, subsequently, retrieve additional quota when that quota allocation has been consumed. In a general sense, client services packet gateway 14 may be responsible for quota enforcement for end user 12.

Loggen element 24 is a storage element operable to build billing records and communicate the billing records to BMA 44 based on information provided by KUT 26. Even in cases where the information returned by KUT 26 reflects a null (e.g., no active BMA), this may be communicated to GTP element 30a, which may use the value to determine the destination and queue(s) to use or to invoke for a corresponding billing record. Loggen element 24 may also operate to store data for later use and execute all formatting for billing records to be communicated to BMA 44. Loggen element 24 may be implemented using hardware, software, or any other suitable element or object operable to store information and to generate a billing record to be communicated to BMA 44. Loggen element 24 may communicate with BMA 44 in order to log quota usage data associated with end user 12. Loggen element 24 may generate logging records or billing records and additionally send messages to billing system element 40 associated with a change in SGSN.

KUT 26 is a data storage element that manages one or more correlations between the ID of end user 12 and a corresponding IP address. KUT 26 may also store information relating to BMA 44, previously designated to end user 12, and BMA 44 may be invoked when additional information associated with end user 12 is communicated to client services packet gateway 14. KUT 26 may be consulted as additional billing records are created in order to determine that BMA 44 should receive selected billing records. KUT 26 may also include an application program interface (API) that may be implemented in order to obtain user ID information for an IP address from a data flow.

Client services packet gateway 14 and billing system element 40 may implement any suitable communications protocol in order to exchange information. In an example embodiment, GTP elements 30a-d may be used as a communications protocol or platform for such communications. Alternatively, client services packet gateway 14 and billing system element 40 (or BMA 44) may implement any communications protocol or tunneling communication link in order to provide for a suitable data exchange. GTP elements 30a-d may be included in client services packet gateway 14 or provided external thereto and be GTP or non-GTP based where appropriate. In one embodiment, GTP elements 30a-d are software communication protocols that describe the acknowledgement (or ACKing) and handshaking operations that may allow recognition of active, operational, and disabled states associated with BMA 44. In addition, GTP elements 30a-d may facilitate the formatting, header information, sequencing, and other communication parameters in order to effectively deliver data or information between client services packet gateway 14 and BMA 44.

A billing record may then be created within client services packet gateway 14 and sent to BMA 44. A look-up operation may then be performed in order to correlate the IP address of end user 12 in KUT 26 to the user ID that may be included in that billing record. With this information provided, BMA 44 may now be assigned for this end user (if end user 12 is a new user). If this information or data flow is associated with an existing end user 12, it may be determined that BMA 44 was previously used by end user 12.

Quota manager element 36 is an element that manages quota information for services subscribed to by end user 12. Quota manager element 36 also provides an interface between GGSNs 32a and 32b and billing system element 40. Quota manager element 36 may also communicate with billing system element 40 in order to exchange information associated with charging for end user 12. Quota manager element 36 may also receive RADIUS updates from GGSN 32a or 32b that reflect the current status associated with end user 12.

Configurable protocol parser 38 is an object that may receive new billing instructions associated with a new, unknown, or emerging protocol or protocol extension within a packet or packet flow. Configurable protocol parser 38 allows the operator or authorized user of client services packet gateway to quickly develop billing instructions and/or billing policies for the new, unknown, or emerging protocols or protocol extensions. Configurable protocol parser 38 may use a simple and efficient method, such as utilizing primitive matching methods, for determining if a billing action should occur for new, unknown, or emerging protocols or protocol extensions. As a result, the operator or authorized user of client services packet gateway 14 may develop these new billing instructions and/or billing policies on their own. Therefore, configurable protocol parser 38 allows an operator or authorized individual of configurable protocol parser to quickly respond to these new or unknown protocols by writing simple billing instructions. Additionally, the simple matching utilized by configurable protocol parser 38 is fault tolerant, such that only a portion of a protocol, as opposed to the entire protocol, is required to be identified to perform a billing action. The simple matching utilized by configurable protocol parser 38 also requires little processing power.

It is critical to note that client services packet gateway 14 and configurable protocol parser 38 may include any suitable elements, hardware, software, objects, or components capable of effectuating their operations or additional operations where appropriate. Additionally, any one or more of the elements included in client services packet gateway 14 and configurable protocol parser 38 may be provided in an external structure or combined into a single module or device where appropriate. Moreover, any of the functions provided by these two elements may be offered in a single unit or single functionalities may be arbitrarily swapped between client services packet gateway 14 and configurable protocol parser 38. The embodiment offered in FIG. 1A has been provided for purposes of example only. The arrangement of elements (and their associated operation(s)) may be reconfigured significantly in any other appropriate manner in accordance with the teachings of the present disclosure.

In one particular embodiment, configurable protocol parser 38 may be configured to associate one or more billing instructions for a particular protocol. Configurable protocol parser 38 may utilize one or more primitive matching elements for determining if a new, unknown, or emerging protocol or protocol extension is contained in the packet or packet flow. The one or more primitive matching elements may be fixed byte patterns, regular expressions, offsets, etcetera. As an example, the primitive matching elements allow matching for at least the following: a fixed pattern of consecutive tokens; a fixed pattern of consecutive tokens located at a specified location; a variable pattern of nonconsecutive tokens; and a fixed wild card pattern of consecutive tokens, such that the fixed wild card pattern includes one or more wild card tokens. A token may be any symbol, character, number, or space. A token combination may be one or more tokens. For example, a token may be a ‘x’, ‘3’, ‘:’, ‘ ’, etcetera. A token combination may be “x3:”. A special token, such as ‘*’, may be utilized as a wildcard token to match any type of token.

In one particular embodiment, these simplified pattern matching techniques for new, unknown, or emerging protocols may not be operable for processing recursive patterns. However, several advantages are gained by utilizing simplified pattern techniques by configurable protocol parser 38, including a simplified user interface for an operator or authorized individual attempting to identify the new, unknown, or emerging protocol, such that billing actions for the new, unknown, or emerging protocol can be implemented very quickly. Another advantage includes a fault tolerant and simple method for identifying the new, unknown, or emerging protocol, such that complex algorithms for tracking an entire protocol are not needed. Normally, complex algorithms for tracking an entire protocol may cause errors if an entire protocol is not tracked completely, such that proper billing actions cannot be taken on the protocol. Additionally, the partial matching of a protocol provided by configurable protocol parser allows for operator or authorized individual to experiment with billing a new, unknown, or emerging protocol before full billing support of the new, unknown, or emerging protocol exists.

In one particular embodiment, configurable protocol parser 38 may be configured to perform one or more billing actions if a portion of a new, unknown, or emerging protocol or protocol extension is matched to a token combination associated with the new, unknown, or emerging protocol or protocol extension. The one or more billing actions may generate a billing record, track data, deny one or more packets, permit one or more packets, etcetera. As an example, the billing actions may include at least the following scenarios: associating one or more packets with a communication session that utilizes a new, unknown, or emerging protocol or protocol extension; tracking billing data associated with a communication session that utilizes a new, unknown, or emerging protocol or protocol extension; generating a partial billing record for one or more packets associated with a communication session that utilizes a new, unknown, or emerging protocol or protocol extension; generating a complete billing record for a one or more packets associated with a communication session that utilizes a new, unknown, or emerging protocol or protocol extension; and denying one or more packets from reaching a destination that are associated with a communication session that utilizes a new, unknown, or emerging protocol or protocol extension.

In one particular embodiment, configurable protocol parser 38 allows operator or authorized user of client services packet gateway 14 to configure client services packet gateway 38 to identify a communication session or a network flow associated with a configured category. A particular configured category may be associated with a known content type or a known billing policy for an already existing protocol. Billing policies and/or billing instructions for known protocols may already exist on one or more parsers located on client services packet gateway 14. Configurable protocol parser 38 allows operator or authorized individual to configure one or more new billing actions for a matched token combination associated with a new, unknown, or emerging protocol or protocol extension, such that the one or more new configured billing actions are an extension of an existing parser for a known protocol.

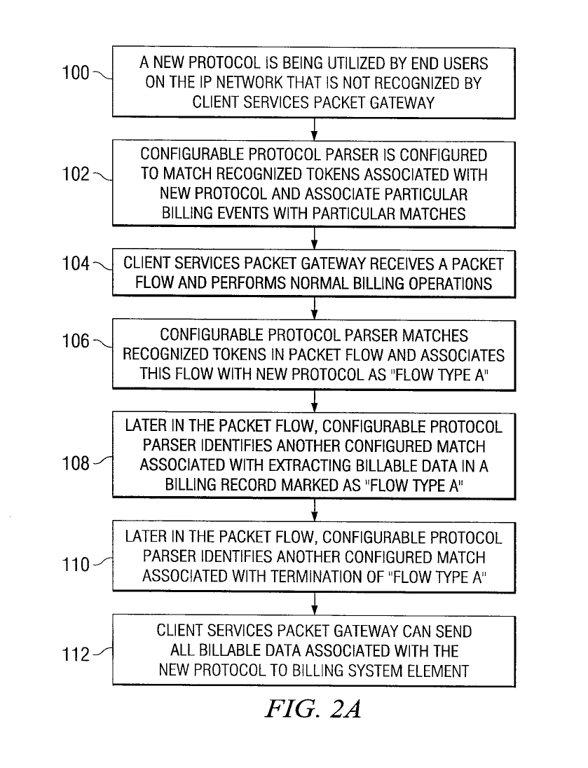

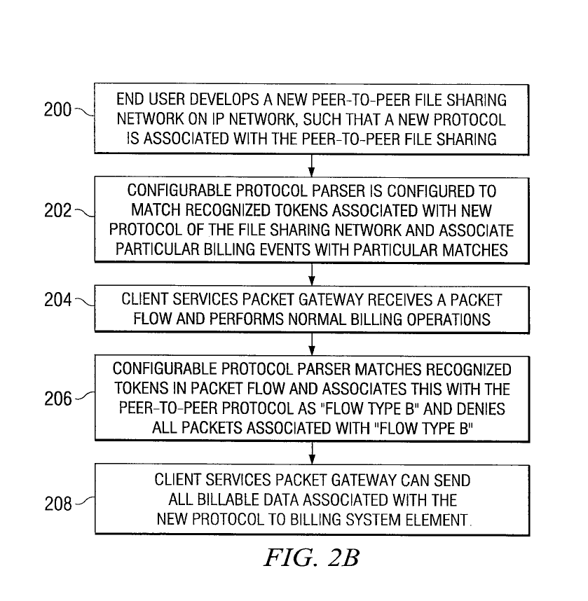

In an example operation, end users 12 may begin embedding WAP2 messages within the payload of an HTTP protocol. Operators or authorized users of client services packet gateway 14 may want to perform a new billing action for HTTP protocols containing the WAP2 messages within the payload. Normally, client services packet gateway 14 would not be updated for several weeks or months while a new billing policy was implemented for the entire HTTP protocol containing a WAP2 message within the payload. However, configurable protocol parser 38 allows operator or authorized user to immediately configure a billing action for an HTTP protocol containing a WAP2 message within the payload. After analyzing the packets with an HTTP protocol containing a WAP2 message within the payload, operator or authorized user may recognize a particular pattern associated with this new protocol extension, such as the token combination “4545” offset ten spaces from the token combination “HTTP:”. Operator or authorized user can immediately utilize configurable protocol parser 38 to configure a billing action, such as generating a billing record identifying the WAP2 payload, when the packet flow contains the matched token combination of “HTTP:**********4545”, such that ‘*’ may represent a wild card that can match to any token. Operator or authorized user of client services packet gateway may provide any customized billing action for the WAP2 messages embedded in an HTTP protocol, such that each operator or authorized user can perform unique billing actions associated with a new, unknown, or emerging protocol or protocol extension. Further examples of operations and processes associated with the elements included within configurable protocol parser 38 are described below with reference to FIGS. 1B, 2A, and 2B.

Billing system element 40 is an object that manages the billing and access policies associated with a given end user 12. Configurable protocol parser 38 may communicate billing actions, billing policies, and/or values from packet to billing system element 40. In one embodiment, billing system element 40 includes quota server 42, BMA 44, price server 50, and advice of charge server 60. Client services packet gateway 14 may communicate with billing system element 40 in order to retrieve information or learn of billing policies for end user 12.

FIG. 1B is a simplified block diagram of configurable protocol parser 38 included within communication system 10. Operator or authorized user or client services packet gateway 14 may configure configurable protocol parser 38 to perform billing actions for a new, unknown, or emerging protocol or protocol extension. One or more billing instruction entries may be added by operator or authorized user of client services packet gateway 14. Each billing instruction may include one or more token combinations associated with a portion of a new, unknown, or emerging protocol or protocol extension, and one or more billing actions to be performed for the matched token combination.

A sample packet may include a header, payload, and a trailer section. The header may include one or more fields, such as the sender's IP address, destination IP address, and header control data for a protocol. The payload may include the data being transported. The trailer may include the trailer control data for a protocol. Each field in the header, payload, and trailer is made up of one or more tokens.

As each packet is received by client services packet gateway, configurable protocol parser 38 may determine if any of the token combinations associated with a new, unknown, or emerging protocol or protocol extension are matched to any portion of the token combinations within the header, payload, or trailer of the received packet. In one embodiment, configurable protocol parser 38 may use any suitable technique to avoid ambiguous matches for multiple token combinations. For example, configurable protocol parser 38 may utilize use a priority order for matching token combinations. If a token combination from a billing instruction is matched to a token combination in the packet, then configurable protocol parser may perform the billing action associated with the token combination for that particular billing instruction. After the billing action is performed, configurable protocol parser 38 may continue to determine if any of the token combinations associated with a new, unknown, or emerging protocol or protocol extension are matched to the remaining portion of the token combinations within the received packet.

In one embodiment, configurable protocol parser 38 may utilize a priority order for each token combination. The priority order for the one or more token combinations may prevent ambiguous matching. Additionally, the priority order for the one or more token combinations allows configurable protocol parser 38 to be flexible in matching the one or more token combinations.

FIG. 2A is a simplified flowchart illustrating an example method for providing billing instructions associated with a new protocol or protocol extension. The flowchart may begin at step 100 where a new protocol is being utilized by end users on the IP network. Client services packet gateway does not recognize the new protocol, and cannot perform billing actions based on the new protocol. Service provider or operator of client services packet gateway may analyze packet flow to identify characteristics or token combinations associated with the new protocol.

At step 102, in response to the new protocol, service provider or an operator of client services packet gateway 14 quickly configures the configurable protocol parser 38 with one or more billing instructions associated with the new protocol. The service provider or operator of client services packet gateway 14 is able to utilize the configurable protocol parser 38 to provide one or more billing instructions associated with the new protocol prior to the release of software that can fully parse the entire protocol for complete billing capabilities. Each billing instruction may include one or more token combinations associated with a portion of the new protocol, and one or more billing actions to be performed for the matched token combination.

At step 104, client services packet gateway 14 receives a packet flow and performs normal billing operations associated with the packet flow. At step 106, configurable protocol parser 38 utilizes billing instructions to match a recognized token combination associated with the new protocol. Configurable protocol parser 38 may perform a billing action, in response to this matched token combination, to associate this packet flow with the new protocol as “Flow type A”. Client services packet gateway 14 may do a normal user authorization for this flow type, including associating the flow type with a billing policy, such as a prepaid service.

At step 108, client services packet gateway 14 continues to receive the packet flow. Later in the packet flow, configurable protocol parser 38 identifies another matched token combination in the packet flow associated with the new protocol. Configurable protocol parser 38 may perform a billing action, in response to this matched token combination, to generate a full generic transaction report for “flow type A” based on the statistics for this flow up to the matched token combination. Statistics may be billable data extracted from the packet flow.

At step 110, client services packet gateway 14 continues to receive the packet flow. Later in the packet flow, configurable protocol parser 38 identifies another matched token combination in the packet flow associated with the new protocol. This matched token combination may identify the end of the protocol. Configurable protocol parser 38 may perform multiple billing actions, in response to this matched token combination, to stop associating this packet flow as “flow type A” and generate a final generic summary billing record, marked as “flow type A”, for the entire packet flow associated with “flow type A”.

At step 112, client services packet gateway 14 may send all billable data associated with the new protocol to billing system element 40.

FIG. 2B is another simplified flowchart illustrating an example method for providing billing instructions associated with a new protocol or protocol extension. The flowchart may begin at step 200 where a new protocol has been developed by an end user for an illegal peer-to-peer file sharing network connected to IP network. Client services packet gateway 14 does not recognize the new protocol, and cannot perform billing actions based on the new protocol. A service provider or operator of client services packet gateway 14 may analyze packet flow to identify characteristics or token combinations associated with the new protocol.

At step 202, in response to the new protocol, a service provider or operator of client services packet gateway 14 quickly configures the configurable protocol parser with one or more billing instructions associated with the new protocol. The service provider or operator of client services packet gateway 14 is able to utilize the configurable protocol parser 38 to provide one or more billing instructions associated with the new protocol prior to the release of software that can fully parse the entire protocol for complete billing capabilities. Each billing instruction may include one or more token combinations associated with a portion of the new protocol, and one or more billing actions to be performed for the matched token combination.

At step 204, client services packet gateway 14 receives a packet flow and performs normal billing operations associated with the packet flow. At step 206, configurable protocol parser 38 utilizes billing instructions to match a recognized token combination associated with the new protocol. Configurable protocol parser 38 may perform multiple billing actions, in response to this matched token combination, to associate this peer-to-peer packet flow with the new protocol as “Flow type B”, and deny all packets associated with “Flow type B”.

At step 208, client services packet gateway 14 may send all billable data associated with the new protocol to billing system element 40.

Some of the steps illustrated in FIGS. 2A-B may be changed or deleted where appropriate and additional steps may also be added to the flowcharts. These changes may be based on specific communication architectures or particular interfacing arrangements and configurations of associated elements and do not depart from the scope or the teachings of the present disclosure. The interactions and operations of the elements within configurable protocol parser 38, billing system element 40, and client services packet gateway 14, as disclosed in FIGS. 2A-B, have provided merely one example for their potential applications. Numerous other applications may be equally beneficial and selected based on particular networking needs.

Although the present disclosure has been described in detail with reference to particular embodiments, communication system 10 may be extended to any scenario in which end user 12 is provided with a service in the context of a wired or a wireless connection or coupling. This may also be extended to any other network architectures and include communications with some type of access server (e.g. a network access server (NAS), foreign agents, etc.). End user 12 may use a dedicated connection of some form or use forms of multiple access protocols where appropriate. Access may be associated with a PPP architecture or alternatively with layer three protocols over a layer two in accordance with particular needs. Moreover, significant flexibility is provided by communication system 10 in that any suitable one or more components may be replaced with other components that facilitate their operations. For example, RAN 16 and SGSNs 18a and 18b may be replaced by an access network or by a packet data serving node (PDSN). Additionally, GGSNs 32a and 32b may be replaced by a home agent or a NAS where appropriate.

Additionally, although communication system 10 has been described with reference to a number of elements included within client services packet gateway 14 and billing system element 40, these elements may be rearranged or positioned anywhere within communication system 10. In addition, these elements may be provided as separate external components to communication system 10 where appropriate. The present disclosure contemplates great flexibility in the arrangement of these elements as well as their internal components. For example, in an alternative embodiment client services packet gateway 14 may include billing system element 40 or BMA 44 or these elements may be provided in a single module. Moreover, although FIGS. 1 and 2 illustrate an arrangement of selected elements, such as client services packet gateway 14 inclusive of quota manager element 36, loggen element 24, or GTP elements 30a-d, numerous other components may be used in combination with these elements or substituted for these elements without departing from the teachings of the present disclosure. Additionally, client services packet gateway 14 may be positioned in any suitable point of a data flow such that it may extract information used for generating a billing record. Additionally, configurable protocol parser 38 may be located in any billing gateway or any device operable to control or process data flows.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A method, comprising:
receiving one or more billing instructions, the billing instructions operable to initiate one or more billing actions associated with a protocol; and
performing the billing actions when one or more token combinations associated with the billing instructions match a portion of the protocol, wherein the matched portion of the protocol is associated with a new, unknown, or emerging protocol or protocol extension.

2. The method of claim 1, further comprising:
receiving one or more packets;
extracting a plurality of tokens from the one or more packets;
determining if a selected portion of the plurality of tokens match a selected token combination associated with the one or more billing instructions, wherein the matched token combination is the portion of the protocol; and
performing the one or more billing actions associated with the matched token combination.

3. The method of claim 1, wherein the one or more billing actions are selected from a group of billing actions consisting of:
a) associating a portion of the plurality of packets with a communication session;
b) tracking billing data associated with a portion of the plurality of packets associated with a communication session;
c) generating a partial billing record for a portion of the plurality of packets associated with a communication session;
d) generating a complete billing record for a portion of the plurality of packets associated with a communication session; and
e) denying the portion of a plurality of packets associated with a communication session from reaching a destination.

4. The method of claim 1, wherein the billing instructions are written and received, from a network operator, prior to receiving software operable to track the entire new, unknown, or emerging protocol or protocol extension.

5. The method of claim 1, wherein the one or more token combinations are selected from a group of one or more token combinations consisting of:
a) a fixed pattern of consecutive tokens;
b) a fixed pattern of consecutive tokens located at a specified location;
c) a variable pattern of nonconsecutive tokens; and
d) a fixed wild card pattern of consecutive tokens, wherein the fixed wild card pattern comprises one or more wild card tokens.

6. The method of claim 1, further comprising:
receiving one or more packets;
extracting a plurality of tokens from the one or more packets;
determining if a first selected portion of the plurality of tokens match a first selected token combination associated with the one or more billing instructions;
associating a first priority order with the first selected token combination;
determining if a second selected portion of the plurality of tokens match a second selected token combination associated with the one or more billing instructions; and
associating a second priority order with the second selected token combination.

7. The method of claim 1, wherein the billing instructions are received prior to receiving an advanced set of billing instructions operable to track the entire new, unknown, or emerging protocol.

8. The method of claim 1, wherein the one or more received billing instructions are loaded to a client services packet gateway, wherein the client services packet gateway comprises previously loaded billing instructions associated with existing protocols.

9. An apparatus, comprising:
a configurable protocol parser operable to:
receive one or more billing instructions, the billing instructions operable to initiate one or more billing actions associated with a protocol; and
perform the billing actions when one or more token combinations associated with the billing instructions match a portion of the protocol, wherein the matched portion of the protocol is associated with a new, unknown, or emerging protocol or protocol extension.

10. The apparatus of claim 9, wherein the configurable protocol parser is further operable to:
receive one or more packets;
extract a plurality of tokens from the one or more packets;
determine if a first selected portion of the plurality of tokens match a first selected token combination associated with the one or more billing instructions;
associate a first priority order with the first selected token combination;
determine if a second selected portion of the plurality of tokens match a second selected token combination associated with the one or more billing instructions; and
associate a second priority order with the second selected token combination.

11. The apparatus of claim 9, wherein the one or more billing actions are selected from a group of billing actions consisting of:
a) associating a portion of the plurality of packets with a communication session;
b) tracking billing data associated with a portion of the plurality of packets associated with a communication session;
c) generating a partial billing record for a portion of the plurality of packets associated with a communication session;
d) generating a complete billing record for a portion of the plurality of packets associated with a communication session; and
e) denying the portion of a plurality of packets associated with a communication session from reaching a destination.

12. The apparatus of claim 9, wherein the billing instructions are written and received, from a network operator, prior to receiving software operable to track the entire new, unknown, or emerging protocol or protocol extension.

13. The apparatus of claim 9, wherein the one or more token combinations are selected from a group of one or more token combinations consisting of:
a) a fixed pattern of consecutive tokens;
b) a fixed pattern of consecutive tokens located at a specified location;
c) a variable pattern of nonconsecutive tokens; and
d) a fixed wild card pattern of consecutive tokens, wherein the fixed wild card pattern comprises one or more wild card tokens.

14. The apparatus of claim 9, wherein the configurable protocol parser is further operable to:
receive one or more packets;
extract a plurality of tokens from the one or more packets;
determine if a selected portion of the plurality of tokens match a selected token combination associated with the one or more billing instructions; and
associate a priority order with the selected token combination.

15. The apparatus of claim 9, wherein the billing instructions are received prior to receiving an advanced set of billing instructions operable track the entire new, unknown, or emerging protocol.

16. The apparatus of claim 9, wherein the one or more received billing instructions are loaded to a client services packet gateway, wherein the client services packet gateway comprises previously loaded billing instructions associated with existing protocols.

17. An apparatus, comprising:
means for receiving one or more billing instructions, the billing instructions operable to initiate one or more billing actions associated with a protocol; and
means for performing the billing actions when one or more token combinations associated with the billing instructions match a portion of the protocol, wherein the matched portion of the protocol is associated with a new, unknown, or emerging protocol or protocol extension.

18. The apparatus of claim 17, further comprising:
means for receiving one or more packets;
means for extracting a plurality of tokens from the one or more packets;
means for determining if a selected portion of the plurality of tokens match a selected token combination associated with the one or more billing instructions, wherein the matched token combination is the portion of the protocol; and
means for performing the one or more billing actions associated with the matched token combination.

19. The apparatus of claim 17, wherein the one or more billing actions are selected from a group of billing actions consisting of:
a) associating a portion of the plurality of packets with a communication session;
b) tracking billing data associated with a portion of the plurality of packets associated with a communication session;
c) generating a partial billing record for a portion of the plurality of packets associated with a communication session;
d) generating a complete billing record for a portion of the plurality of packets associated with a communication session; and
e) denying the portion of a plurality of packets associated with a communication session from reaching a destination.

20. The apparatus of claim 17, wherein the billing instructions are written by a network operator, prior to receiving software operable to track the entire new, unknown, or emerging protocol.
